(19) United States
(12) Patent Application Publication
(10) Pub. No.: US 2009/0206053 A1
(43) Pub. Date: Aug. 20, 2009

(54) PLASMA ETCHING METHOD, PLASMA ETCHING APPARATUS, CONTROL PROGRAM AND COMPUTER-READABLE STORAGE MEDIUM

(75) Inventors: Akitaka Shimizu, Nirasaki City (JP); Masanobu Honda, Nirasaki City (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/388,192

(22) Filed: Feb. 18, 2009

Related U.S. Application Data
(60) Provisional application No. 61/055,548, filed on May 23, 2008.

(30) Foreign Application Priority Data
Feb. 19, 2008 (JP) 2008-036993

(51) Int. Cl. B44C 1/22; C23F 1/08

(52) U.S. Cl. 216/47; 216/41; 156/345.24

(57) ABSTRACT

A plasma etching method etching an organic underlayer film formed on a target substrate by using a plasma of a processing gas via a pattered mask layer formed on the underlayer film. The processing gas includes a gaseous mixture of an oxygen-containing gas and a sulfur-containing gas not having oxygen. The oxygen-containing gas is one of O₂ gas, CO gas, CO₂ gas or a combination thereof and the mask layer is formed of a silicon-containing inorganic compound.

### FIELD OF THE INVENTION

The present invention relates to a plasma etching method for plasma etching, via a mask, an underlayer such as an organic film or a silicon nitride film formed under the mask layer which has a specific pattern and is formed on a substrate by generating a plasma of a processing gas and also relates to a plasma etching apparatus, a control program and a computer-readable storage medium to be used therein.

### BACKGROUND OF THE INVENTION

Conventionally, in a manufacturing process for a semiconductor device, an organic film or a silicon nitride film is plasma etched via a mask to have a desired pattern thereon. As for such plasma etching method, there is known a technique for performing micro-processing with a high accuracy by using a multilayer resist mask.

In a plasma etching process using the above-mentioned multilayer resist mask, there is known a plasma etching method in which, as an underlayer, a silicon-containing inorganic compound film such as an SOG (spin-on glass) film, a Si-ARC (silicon antireflective coating) film or the like is plasma etched to form a specific pattern thereon while using, e.g., an ArF resist film of a specific pattern as a mask formed thereon and, then, an underlayer resist film formed of an organic film is plasma etched by using the silicon-containing inorganic compound film as a mask.

Conventionally, when the underlayer resist film formed of an organic film is plasma etched by using the silicon-containing inorganic compound film, processing gases (etching gas), e.g., CO+O₂+N₂, CO₂+O₂+N₂, CO+N₂ and the like are used. However, such processing gases do not include a deposition gas for protecting a side wall of a chamber in the plasma etching process.

Accordingly, there occur problems that a line is formed to be thin or a hole diameter becomes wide. Further, although CH₂F₂, CHF₃ and like are generally used as the deposition gas to protect a side wall, such fluorine-containing gas cannot be used when the silicon-containing inorganic compound film is used as a mask because the mask layer can be etched.

Further, when a BARC (bottom anti-reflective coating) film formed of an organic film is plasma etched in an oxygen gas atmosphere by using a resist film as a mask, the resist film is also etched. As a result, pattern sizes vary, whereby it is difficult to control the pattern sizes. Therefore, to solve these problems there is provided a technique in which a sulfur-containing gas such as SO₂ and the like is mainly used as a processing gas (see, for instance, Japanese Patent Laid-open Application No. 2004-363150).

In the above-described plasma etching, in which, e.g., an underlayer resist film formed of an organic film is plasma etched by using the silicon-containing inorganic compound film as a mask, there is no side wall protection unit, a width of the formed line is narrow, the hole diameter and a desirable size and shape of the pattern cannot be obtained.

### SUMMARY OF THE INVENTION

In view of the foregoing, the present invention provides a plasma etching method capable of performing a size control and a shape control with a higher density compared with the conventional etching method and obtaining an etching pattern having a desirable size and shape. Further, the present invention also provides a plasma etching apparatus, a control program and a compute-readable storage medium to be used therefor.

In accordance with a first aspect of the present invention, there is provided a plasma etching method including: etching an organic underlayer film formed on a target substrate by using a plasma of a processing gas via a pattered mask layer formed on the underlayer film, wherein the processing gas includes a gaseous mixture of an oxygen-containing gas and a sulfur-containing gas not having oxygen.

The oxygen-containing gas may be one of O₂ gas, CO gas, CO₂ gas or a combination thereof.

The mask layer may be formed of a silicon-containing inorganic compound.

In accordance with a second aspect of the present invention, there is provided a plasma etching method including: etching a silicon nitride underlayer film formed on a target substrate by using a plasma of a processing gas via a patterned mask layer formed on the underlayer film, wherein the processing gas includes a sulfur-containing gas not having oxygen.

The sulfur-containing gas not having oxygen may be one of CS₂ gas, H₂S gas and S₂Cl₂ gas or a combination thereof.

In accordance with a third aspect of the present invention, there is provided a plasma etching method for etching an etching target layer formed on a substrate by using a multilayer mask at least having a first silicon-containing inorganic compound layer, a first resist layer, a second silicon-containing inorganic compound layer and a second resist layer formed in that order directly on the etching target layer.

The plasma etching method includes: patterning the second silicon-containing inorganic compound layer by using the second resist layer; etching the first resist layer by using a plasma of a processing gas including at least an oxygen-containing gas and a sulfur-containing gas not having oxygen through the use of patterned the second silicon-containing inorganic compound layer as a mask; forming a hard mask by etching the first silicon-silicon-containing inorganic compound layer via the resist mask; and etching the etching target layer via the hard mask.

In accordance with a fourth aspect of the present invention, there is provided a plasma etching apparatus including: a processing chamber for accommodating a target substrate therein; a processing gas supply unit for supplying a processing gas into the processing chamber; a plasma generating unit for generating a plasma of the processing gas supplied from the processing gas supply unit and processing the target substrate by the plasma; and a control unit for controlling the plasma etching method described above in the processing chamber.

In accordance with a fifth aspect of the present invention, there is provided a computer-executable control program for controlling, when executed, a plasma etching apparatus to perform the plasma etching method described above.

In accordance with a sixth aspect of the present invention, there is provided a computer-readable storage medium storing therein a computer-executable control program, wherein the control program controls a plasma etching apparatus to perform the plasma etching method described above.

In accordance with the aspects of the present invention, there can be provided a method for performing a size control and a shape control with a higher density compared with the conventional etching method and obtaining an etching pattern having a desirable size and shape. Further, the present invention also provides a plasma etching apparatus, a control program and a compute-readable storage medium to be used therefor.

### BRIEF DESCRIPTION OF THE DRAWINGS

The objects and features of the present invention will become apparent from the following description of embodiments given in conjunction with the accompanying drawings, in which:

FIGS. 1A to 1D provide cross sectional views of a semiconductor wafer to which a plasma etching method in accordance with a first embodiment of the present invention is applied;

FIG. 2 is a schematic configuration view of a plasma etching apparatus in accordance with the embodiment of the present invention; and

FIGS. 3A to 3D provide cross sectional views of a semiconductor wafer to which a plasma etching method in accordance with an embodiment of the present invention is applied.

### DETAILED DESCRIPTION OF THE EMBODIMENTS

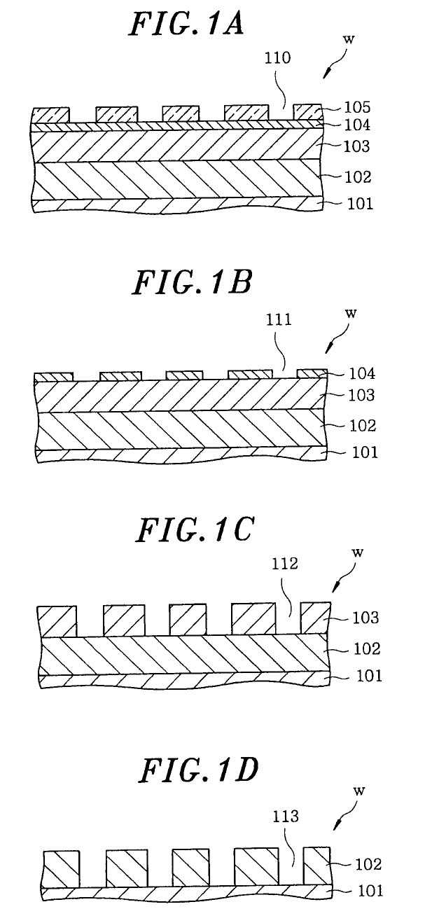

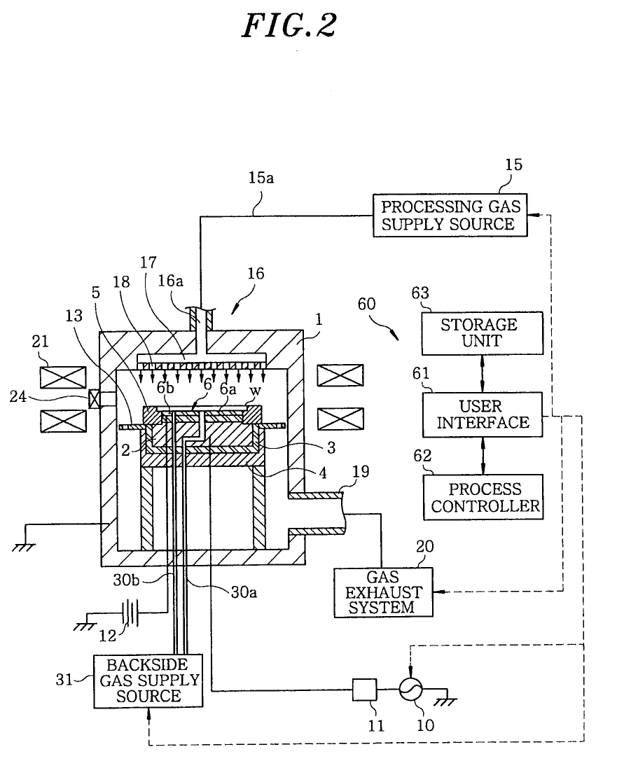

The embodiments of the present invention will be described with reference to the accompanying drawings which form a part hereof. FIGS. 1A to 1D provide cross sectional views of a semiconductor wafer to which a plasma etching method in accordance with a first embodiment of the present invention is applied. Further, FIG. 2 is a schematic configuration view of a plasma etching apparatus in accordance with the embodiment of the present invention. First, the configuration of a plasma etching apparatus will be explained in connection with FIG. 2.

The plasma etching apparatus includes a processing chamber 1 airtightly configured and electrically grounded. The processing chamber 1 has a cylindrical shape and is made of, e.g., aluminum. Disposed in the processing chamber 1 is a mounting table 2 for horizontally supporting thereon a semiconductor wafer W, which is a target substrate. The mounting table 2, which is made of, e.g., aluminum, is supported by a conductive support 4 via an insulating plate 3. Further, a focus ring 5 formed of, e.g., single-crystalline silicon is disposed at the periphery of the top portion of the mounting table 2.

An RF power supply 10 is connected to the mounting table 2 via a matching box 11. A high frequency power of a specific frequency (e.g., 13.56 MHz) is supplied from the RF power supply 10 to the mounting table 2. A shower head 16 is disposed above the mounting table 2, while facing the mounting table 2 in parallel, and the shower head is electrically grounded. Accordingly, the mounting table 2 and the shower head 16 are configured to function as a pair of electrodes.

An electrostatic chuck 6 for electrostatically attracting and holding the semiconductor wafer W is provided on a top surface of the mounting table 2. The electrostatic chuck 6 is formed of an insulator 6b and an electrode 6a embedded therein, and the electrode 6a is connected to a DC power supply 12. The semiconductor wafer W is attracted and held by a Coulomb force generated by applying a DC voltage to the electrode 6a from the DC power supply 12.

A coolant path (not shown) is formed inside the mounting table 2. By circulating a proper coolant, e.g., cooling water, through the coolant path, the temperature of the mounting table 2 is regulated at a specific temperature level. Further, backside gas supply channels 30a and 30b for supplying a cold heat transfer gas (backside gas) such as helium gas or the like to the rear side of the semiconductor wafer W is formed through the mounting table 2 and so forth. These backside gas supply channels 30a and 30b are connected to a backside gas (helium gas or the like) supply source 31. The backside gas supply channel 30a supplies the backside gas to a central portion of the wafer W, and the backside gas supply channel 30b supplies the backside gas to a peripheral portion of the wafer W. Further, the pressure of the backside gas is controlled depending on the supply portions, i.e., the central portion and the peripheral portion of the wafer W. With these configurations, the semiconductor wafer W held by the electrostatic chuck 6 on the top surface of the mounting table 2 can be regulated to a desired temperature.

Further, a gas exhaust ring 13 is provided at an outer portion of the focus ring 5. The gas exhaust ring 13 is electrically conducted with the processing chamber 1 via the support 4.

The shower head 16 is provided at the ceiling wall of the processing chamber 1. The shower head 16 has a plurality of a gas through holes 18 at the bottom portion thereof and a gas inlet 16a at the upper portion thereof. Further, a gas space 17 is formed in the shower head 16. The gas inlet 16a is connected to one end of a gas supply line 15a, and the opposite end thereof is connected to a processing gas supply system 15 which supplies the processing gas for etching (etching gas). The processing gas is supplied from the processing gas supply system 15 into the gas space 17 via the gas supply line 15a and the gas inlet 16a. Then, the processing gas is supplied from the gas space 17 into the processing chamber 1 in a shower shape via the gas through holes 18.

A gas exhaust port 19 is formed at a bottom portion of the processing chamber 1, and a gas exhaust system 20 is connected to the gas exhaust port 19. By operating a vacuum pump provided in the gas exhaust system 20, the processing chamber 1 can be depressurized to a specific vacuum level. Further, a gate valve 24 for opening and closing a loading/unloading port is provided at a sidewall of the processing chamber 1.

A ring magnet 21 is provided around the processing chamber 1 in a concentric shape, whereby a magnetic field is formed in a space between the mounting table 2 and the shower head 16. The ring magnet 21 can be rotated by a rotation unit (not shown) such as a motor or the like.

The whole operation of the plasma etching apparatus having the above-configuration is controlled by the control unit 60. The control unit 60 includes a process controller 61 having a CPU and controlling parts of the plasma etching apparatus; a user interface 62; and a storage unit 63.

The user interface 62 includes a keyboard for a process manager to input a command to operate the plasma etching apparatus, a display for showing an operational status of the plasma etching apparatus, and the like.

The storage unit 63 stores therein, e.g., recipes including processing condition data and the like and control program (software) to be used in realizing various processes, which are performed in the plasma etching apparatus under the control of the process controller 61. When a command is received from the user interface 62, a necessary recipe is called from the storage unit 63 and it is executed at the process controller 61. Accordingly, a desired process is performed in the plasma etching apparatus under the control of the process controller 61. The control program and/or the recipes including the processing condition data and the like can be retrieved from a computer-readable storage medium (e.g., a hard disk, a CD, a flexible disk, a semiconductor memory, or the like), or can be used on-line by being transmitted from another apparatus via, e.g., a dedicated line, whenever necessary.

Below, there will be explained a sequence for plasma etching an underlayer resist film formed of an organic film and the like formed on a semiconductor wafer W by using the plasma etching apparatus configured as described above. First, the gate valve 24 is opened, and a semiconductor wafer W is loaded from a load lock chamber (not shown) into the processing chamber 1 by a transport robot (not shown) or the like to be mounted on the mounting table 2. Then, the transport robot is retreated from the processing chamber 1, and the gate valve 24 is closed. Subsequently, the processing chamber 1 is evacuated via the gas exhaust port 19 by the vacuum pump in the gas exhaust system 20.

When the inside of the processing chamber 1 reaches a specific vacuum level, a processing gas (etching gas) is supplied from the processing gas supply system 15 into the processing chamber 1. While maintaining the internal pressure of the processing chamber 1 at a specific pressure level, e.g., about 13.3 Pa (100 mTorr), a high frequency power is supplied to the mounting table 2 from the RF power supply 10. At this time, a specific DC voltage is applied from the DC power supply 12 to the electrode 6a of the electrostatic chuck 6, whereby the semiconductor wafer W is attracted and held by the electrostatic chuck 6 by a Coulomb force.

By applying the high frequency powers to the mounting table 2 as described above, an electric field is formed between the shower head 16 serving as an upper electrode and the mounting table 2 serving as a lower electrode. Further, since a horizontal magnetic field is formed by the ring magnet 21, a magnetron discharge is generated by electron drifts in the processing space where the semiconductor wafer W is located. As a result of the magnetic discharge, a plasma of the processing gas is generated, and the underlayer resist film and the like formed on the semiconductor wafer W are etched by the plasma.

After the above-described etching process is finished, the supply of the high frequency power and the processing gas is stopped, and the semiconductor wafer W is unloaded from the processing chamber 1 in a reverse sequence to that described above.

Now, a manufacturing method for a semiconductor device in accordance with a first embodiment of the present invention will be described with reference to FIGS. 1A to 1D. FIGS. 1A to 1D provide enlarged configuration views of major parts of a semiconductor wafer W which is used as a target substrate in the embodiment. In FIG. 1A, an etching target film 101 is formed on a semiconductor wafer W and, as a layer forming a hard mask for etching the etching target film 101, a silicon oxide film 102 is formed in the present embodiment. On the silicon oxide film 102, there is formed a multilayer resist mask including an underlayer resist film 103 formed of an organic film, SOG film (Si-ARC film or CVD-SiON film 104, ArF resist film 105, which are formed in that order from a lower side.

The ArF photoresist film 105 provided as the uppermost layer is patterned through a photolithographic process to have patterned openings 110 of a specific shape (e.g., line shape or hole shape).

The semiconductor wafer W having the above-described configuration is loaded into the processing chamber 1 in the plasma etching apparatus shown in FIG. 2 and is mounted on the mounting table 2. Then, from the state illustrated in FIG. 1A, the SOG film 104 is plasma etched while using the ArF photoresist film 105 as a mask, thereby forming openings 111, as shown in FIG. 1B. In this plasma etching process, a gaseous mixture of CxFy gas or CxHyFz gas, a rare gas and O₂ gas or N₂ gas and the like are used as the processing gas (etching gas).

Thereafter, the underlayer resist film 103 is plasma etched by using, as a mask, the SOG film 104 patterned by the plasma etching described above to form openings 112, whereby the semiconductor wafer becomes in a state of FIG. 1C. In this plasma etching process, a gaseous mixture of an oxygen-containing gas and a sulfur-containing gas not having oxygen is used as the processing gas (etching gas). As the oxygen-containing gas, e.g., one of O₂ gas, CO₂ gas and CO gas or a combination thereof is used. Further, as the sulfur-containing gas not having oxygen, e.g., one of CS₂ gas, H₂S gas and S₂Cl₂ gas or a combination thereof is used. Further, if necessary, a rare gas may be mixed with those gases.

In this plasma etching process, the underlayer resist film 103 as an organic film is plasma etched by mainly using the oxygen-containing gas (e.g., O₂ and the like). Further, the sulfur-containing gas not having oxygen (e.g., CS₂ gas and the like) is added into the main gas to be used as a deposition gas for protecting the sidewall by a reaction between sulfur and carbon. Moreover, the rare gas is used for ignition and stability properties of a plasma and an ion energy transfer without performing a chemical reaction.

As described above, since the sulfur-containing gas not having oxygen such as CS₂ and the like is used as the deposition gas for protecting the sidewall, a size control and a shape control of the underlayer resist film 103 can be performed with a high density and an etching pattern having a desirable size and shape can be obtained without deteriorating a selectivity to the SOG film 104 which is a Si-containing inorganic compound used as the mask layer. In this case, if a flow rate of the CS₂ gas or like and a deposition amount of deposits on the sidewall are great, it is possible to control a width of a line to be thick and a diameter of a hole to be small.

Then, the silicon oxide layer 102 is plasma etched by using, as a mask, the underlayer resist film 103 patterned by the plasma etching described above to form openings 113, whereby the semiconductor wafer becomes in a state of FIG. 1D. The silicon oxide layer 102 becomes a hard mask for etching the etching target film 101. In this plasma etching process, a gaseous mixture of CxFy gas or CxHyFz gas, a rare gas and O₂ gas or N₂ gas and the like are used as the processing gas (etching gas).

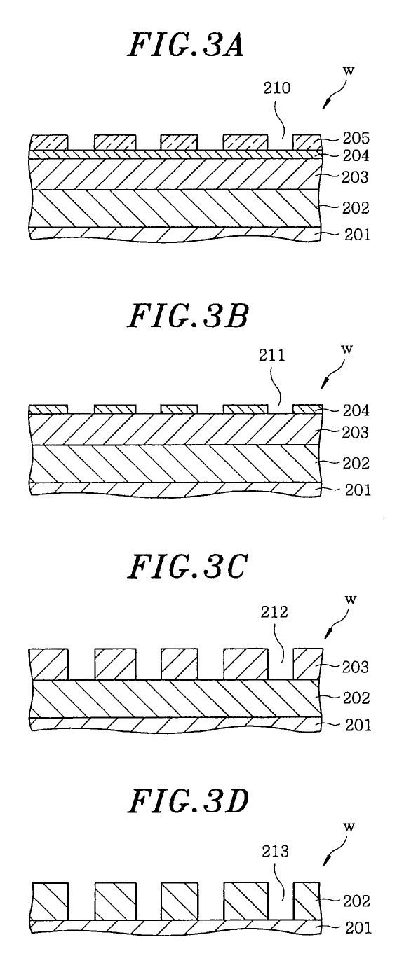

Hereinafter, a second embodiment of the present invention will be described with reference to FIGS. 3A to 3D. FIGS. 3A to 3D provide enlarged configuration views of major parts of a semiconductor wafer W which is used as a target substrate in the second embodiment. In FIG. 3A, an etching target film 201 is formed on a semiconductor wafer W and, as a layer forming a hard mask for etching the etching target film 201, a silicon nitride film 202 is formed in the present invention. On the silicon nitride film 202, there is formed a multilayer resist mask including an underlayer resist film 203 formed of an organic film, SOG film (Si-ARC film or CVD-SiON film 204, ArF resist film 205, which are formed in that order from a lower side.

The ArF photoresist film 205 provided as the uppermost layer is patterned through a photolithographic process to have patterned openings 210 of a specific shape (e.g., line shape or hole shape).

The semiconductor wafer W having the above-described configuration is loaded into the processing chamber 1 in the plasma etching apparatus shown in FIG. 2 and is mounted on the mounting table 2. Then, from the state illustrated in FIG. 3A, the SOG film 204 is plasma etched while using the ArF photoresist film 205 as a mask, thereby forming openings 211, as shown in FIG. 3B. In this plasma etching process, a gaseous mixture of CxFy gas or CxHyFz gas, a rare gas and O₂ gas or N₂ gas and the like are used as the processing gas (etching gas).

Thereafter, the underlayer resist film 203 is plasma etched by using, as a mask, the SOG film 204 patterned by the plasma etching described above to form openings 212, whereby the semiconductor wafer becomes in a state of FIG. 3C. In this plasma etching process, a gaseous mixture of an oxygen-containing gas and a sulfur-containing gas not having oxygen is used as the processing gas (etching gas). As the oxygen-containing gas, e.g., one of O₂ gas, CO₂ gas and CO gas or a combination thereof is used. Further, as the sulfur-containing gas not having oxygen, e.g., one of CS₂ gas, H₂S gas and S₂Cl₂ gas or a combination thereof is used. Further, if necessary, a rare gas may be mixed with those gases.

In this plasma etching process, the underlayer resist film 203 as an organic film is plasma etched by mainly using the oxygen-containing gas (e.g., O₂ and the like). Further, the sulfur-containing gas not having oxygen (e.g., CS₂ gas and the like) is added to the main gas to be used as a deposition gas for protecting the sidewall by a reaction between sulfur and carbon. Moreover, the rare gas is used for ignition and stability properties of a plasma and an ion energy transfer without performing a chemical reaction.

As described above, since the sulfur-containing gas not having oxygen such as CS₂ and the like is used as the deposition gas for protecting the sidewall, the size control and the shape control of the underlayer resist film 203 can be performed with a high density and the etching pattern having a desirable size and shape can be obtained without deteriorating the selectivity to the SOG film 204 which is a Si-containing inorganic compound used as the mask layer. In this case, if the flow rate of the CS₂ gas or like and the deposition amount of the deposits on the sidewall are great, it is possible to control the width of the line to be thick and the diameter of the hole to be small.

Then, the silicon nitride layer 202 is plasma etched by using, as a mask, the underlayer resist film 203 patterned by the plasma etching described above to form openings 213, whereby the semiconductor wafer becomes in a state of FIG. 3D. The silicon oxide layer 202 becomes a hard mask for etching the etching target film 201. In this plasma etching process, CxFy gas or CxHyFz gas, a rare gas, O₂ gas or N₂ gas, a sulfur-containing gas not having oxygen (e.g., one of CS₂ gas, H₂S gas and S₂Cl₂ gas or a combination thereof) and the like are used as the processing gas (etching gas).

As described above, the sulfur-containing gas not having oxygen such as CS₂ gas and the like, which is used as the deposition gas for protecting the sidewall, is also applied for plasma etching the silicon nitride layer 202. Accordingly, the size control and the shape control in the plasma etching of the silicon nitride film 202 can be performed with a higher density compared with the conventional etching method and the etching pattern having a desirable size and shape can be obtained. Further, in this case, if the flow rate of the CS₂ gas or like and the deposition amount of the deposits on the sidewall are great, it is possible to control the width of the line to be thick and the diameter of the hole to be small, as the above-described cases.

As described above, in accordance with the embodiments of the present invention, the size control and the shape control in the plasma etching process can be performed with a higher density compared with the conventional etching process and the etching pattern having a desirable size and shape can be obtained. Further, it is to be noted that the present invention is not limited to the above embodiment but can be modified in various ways.

For example, the plasma etching apparatus is not limited to the parallel plate type apparatus shown in FIG. 2 in which a single high frequency power is applied to the lower electrode, but various other plasma etching apparatuses can be used. For example, the plasma etching apparatus may be of a type in which dual high frequency powers are applied to the upper and the lower electrode or of a type in which dual high frequency powers are applied to the lower electrode. Further, a plasma etching apparatus such as an ICP (inductively-coupled plasma) etching apparatus, a TCP (transfer coupled plasma) etching apparatus, an ECR plasma etching apparatus or the like may also be used.

While the invention has been shown and described with respect to the embodiments, it will be understood by those skilled in the art that various changes and modifications may be made without departing from the scope of the invention as defined in the following claims.

What is claimed is:

1. A plasma etching method comprising: etching an organic underlayer film formed on a target substrate by using a plasma of a processing gas via a pattered mask layer formed on the underlayer film, wherein the processing gas includes a gaseous mixture of an oxygen-containing gas and a sulfur-containing gas not having oxygen.

2. The method of claim 1, wherein the oxygen-containing gas is one of O₂ gas, CO gas, CO₂ gas or a combination thereof.

3. The method of claim 1, wherein the mask layer is formed of a silicon-containing inorganic compound.

4. The method of claim 1, wherein the sulfur-containing gas not having oxygen is one of CS₂ gas, H₂S gas and S₂Cl₂ gas or a combination thereof.

5. The method of claim 2, wherein the sulfur-containing gas not having oxygen is one of CS₂ gas, H₂S gas and S₂Cl₂ gas or a combination thereof.

6. A plasma etching method comprising: etching a silicon nitride underlayer film formed on a target substrate by using a plasma of a processing gas via a patterned mask layer formed on the underlayer film, wherein the processing gas includes a sulfur-containing gas not having oxygen.

7. The method of claim 6, wherein the sulfur-containing gas not having oxygen is one of CS₂ gas, H₂S gas and S₂Cl₂ gas or a combination thereof.

8. The method of claim 6, wherein the processing gas further includes CxFy gas or CxHyFz gas, a rare gas and O₂ gas or N₂ gas.

9. The method of claim 7, wherein the processing gas further includes CxFy gas or CxHyFz gas, a rare gas and O₂ gas or N₂ gas.

10. A plasma etching method for etching an etching target layer formed on a substrate by using a multilayer mask at least having a first silicon-containing inorganic compound layer, a first resist layer, a second silicon-containing inorganic compound layer and a second resist layer formed in that order directly on the etching target layer, the plasma etching method comprising:
patterning the second silicon-containing inorganic compound layer by using the second resist layer;
etching the first resist layer by using a plasma of a processing gas including at least an oxygen-containing gas and a sulfur-containing gas not having oxygen through the use of patterned the second silicon-containing inorganic compound layer as a mask;
forming a hard mask by etching the first silicon-silicon-containing inorganic compound layer via the resist mask; and
etching the etching target layer via the hard mask.

11. The method of claim 9, wherein the oxygen-containing gas is one of O₂ gas, CO gas, CO₂ gas or a combination thereof and the sulfur-containing gas not having oxygen is one of CS₂ gas, H₂S gas and S₂Cl₂ gas or a combination thereof.

12. A plasma etching apparatus comprising:
a processing chamber for accommodating a target substrate therein;
a processing gas supply unit for supplying a processing gas into the processing chamber;
a plasma generating unit for generating a plasma of the processing gas supplied from the processing gas supply unit and processing the target substrate by the plasma; and
a control unit for controlling the plasma etching method described in claim 1 to be executed in the processing chamber.

13. A plasma etching apparatus comprising:
a processing chamber for accommodating a target substrate therein;
a processing gas supply unit for supplying a processing gas into the processing chamber;
a plasma generating unit for generating a plasma of the processing gas supplied from the processing gas supply unit and processing the target substrate by the plasma; and
a control unit for controlling the plasma etching method described in claim 6 to be executed in the processing chamber.

14. A plasma etching apparatus comprising:
a processing chamber for accommodating a target substrate therein;
a processing gas supply unit for supplying a processing gas into the processing chamber;
a plasma generating unit for generating a plasma of the processing gas supplied from the processing gas supply unit and processing the target substrate by the plasma; and a control unit for controlling the plasma etching method described in claim 10 to be executed in the processing chamber.

15. A computer-executable control program for controlling, when executed, a plasma etching apparatus to perform the plasma etching method described in claim 1.

16. A computer-executable control program for controlling, when executed, a plasma etching apparatus to perform the plasma etching method described in claim 6.

17. A computer-executable control program for controlling, when executed, a plasma etching apparatus to perform the plasma etching method described in claim 10.

18. A computer-readable storage medium storing therein a computer-executable control program, wherein the control program controls a plasma etching apparatus to perform the plasma etching method described in claim 1.

19. A computer-readable storage medium storing therein a computer-executable control program, wherein the control program controls a plasma etching apparatus to perform the plasma etching method described in claim 6.

20. A computer-readable storage medium storing therein a computer-executable control program, wherein the control program controls a plasma etching apparatus to perform the plasma etching method described in claim 10.
